(19) United States
(12) Patent Application Publication
(10) Pub. No.: US 2011/0056617 A1
(43) Pub. Date: Mar. 10, 2011

(54) METHOD OF MAKING SPECIAL EVENT CUSTOM SIGNS IN COLOR WITH TEXT AND GRAPHICS

(76) Inventor: Jonathan Haile Cagle, Lafayette, LA (US)

(21) Appl. No.: 12/555,093

(22) Filed: Sep. 8, 2009

(51) Int. Cl. B44C 1/165

(52) U.S. Cl. 156/230

(57) ABSTRACT

To make a special event custom sign, a first transfer paper is made having text and graphics in sublimatable colored ink where each color of the text and graphs is selected using a Pantone number. The first transfer paper is placed on top of a piece of sublimated aluminum and placed in a heat press to make a first multi-color sign. A second transfer paper having the same text and graphics as the first transfer paper is prepared with a new color that replaces at least one color that is not desired and a second multi-color sign that improves on the color of the at least one color not desired is made. Additional transfer papers having the same text and graphics as the second or a subsequent transfer paper that provides colors that are desired are prepared to make special event custom signs with text and graphics in color.

### BACKGROUND OF THE INVENTION

1. Field of the Invention

The present invention relates to a special event sublimated rectangular aluminum member having single or multi-color graphics, images and/or text using Pantone color number charts and Conde System true match color charts to obtain exact colors with sublimatable dyes.

2. Description of Related Art

Sublimation is a process that uses a special ink and a printer to print a pattern, graphics and/or text in various colors on a special sheet of transfer paper. The transfer paper is then placed on a sheet of sublimation aluminum, such as a polymer coasted aluminum, and the sheet of coated aluminum with the transfer paper positioned on top of the aluminum sheet is placed into a hot press. The heat and pressure of the press converts the ink on the transfer paper to a gas which penetrates the coating on the aluminum and becomes a part of the coating. The colored graphics and/or text that was on the transfer paper is transferred to the sublimation aluminum. In many instances, one or more of the colors that were present on the transfer sheet of paper are not the same colors that show up on the sublimation aluminum.

What is needed is a method for making a special event sign for a college or university event that has true colors.

### SUMMARY OF THE INVENTION

In an exemplary embodiment of the present invention, there is disclosed a method of making a special event custom sign comprising:

providing a rectangular piece of sublimated aluminum;

preparing a first transfer paper having text and graphics in sublimatable colored ink;

wherein each color of the text and graphs is selected using a Pantone number;

overlaying the rectangular piece of sublimated aluminum with the first transfer paper;

transferring the text and graphics from the first transfer paper to the sublimated aluminum in a heat press for a time that is not less than 40 seconds or greater that 85 seconds to make a first multi-color sign;

preparing a second transfer paper having the same text and graphics as the first transfer paper with a new Pantone number or a number from Conde Systems True Match Color Chart that replaces at least one color not desired; and

transferring the text and graphics from the second transfer paper to a second rectangular piece of sublimated aluminum in the heat press to make a second multi-color sign that improves enhances and/or corrects the color not desired;

wherein additional transfer papers having the same text and graphics as the second or a subsequent transfer paper that provides colors that are desired to make special event custom signs with text and graphics in color.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram of a method of obtaining true color transfer of colored graphics and/or text to a special event sign of sublimated aluminum by sublimation;

FIG. 2 is a special event custom sign in color with text and graphics made in accordance with the principles of the invention; and

FIG. 3 is another special event custom sign in color with text and graphics made in accordance with the principles of the invention.

### DESCRIPTION OF THE PREFERRED EMBODIMENT

The process of sublimation requires a computer that has a RAM of about 2 gigs and about 250 gigs of hard drive that is coupled to a relatively new monitor that has a good color display and an ink jet printer such as is made by Epson or Ricoh which does not use heat to eject ink out of the printer because sublimation ink is activated by heat. The ink in the printer can be a specific gel or liquid sublimation ink

The computer has one or more software programs which automatically mix the inks to provide the exact colors desired, in addition to template programs, specialty programs and true graphic programs. There are many types of transfer paper that can be used. One type of paper has a coating that keeps the paper from absorbing the ink and uniformly releases the ink when it is heated. If the paper absorbs the ink, the prints will not sublimate evenly. If the ink is not released properly, similar shades of color will blend into each other. The last item that is needed is a heat press that can provide a temperature of between 350 and 450 degrees F. and can heat an area that measures at least 15″×15″ for the small sign and 16″×20″ for the larger sign.

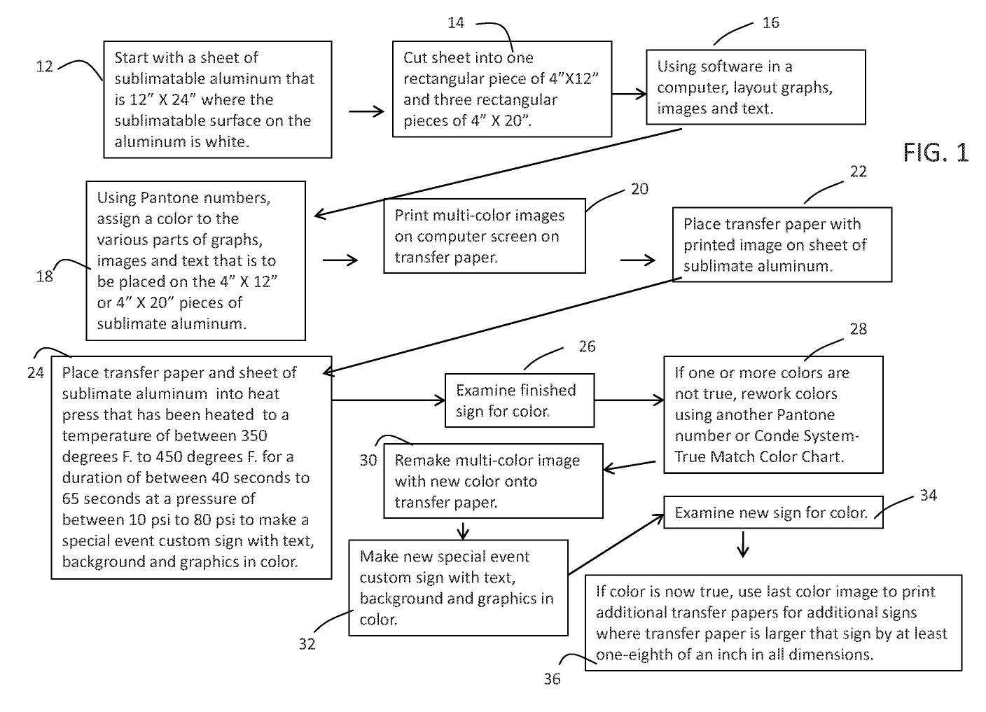

Referring to FIG. 1, there is shown a flow diagram 10 of a method of obtaining true color transfer of colored graphics and/or text to a special event sign of sublimated aluminum by sublimation.

At the start, a sheet of sublimated aluminum that is 12″ by 24″ is provided where the sublimated surface is white, block 12. The sheet is cut into one rectangular piece of 4″ by 12″, and three pieces of 4″ by 20″. The three pieces of 4″×20″ can then be modified by cutting 2″ from the length to provide three pieced that are 4″×18″ more or less. The corners of each piece can remain with a square corner or they can be rounded with a one-quarter inch die press or a one-half inch die press. It is understood that the final dimensions of the pieces or blank is not critical and that pieces or blanks having other dimensions can be used. The various pieces or the blanks that will be made into signs, block 14. Using software in a computer, the graphics, images, background, and/or text of a sign is placed on the computer screen that measures either 4.125″×12, block 16. Using the Pantone color system, colors are assigned to the various parts of the graphics, image, background and/or text that is to be placed on the 4″ by 12″ or 4″ by 20″ pieces of sublimation aluminum, block 18.

The image on the computer screen is printed on a sheet of transfer paper, block 20. The transfer paper with the printed image on the sheet of paper is placed on the rectangular piece of sublimation aluminum, block 22. The transfer paper and the rectangular piece of aluminum are placed into a heated press that has been brought to a temperature of between 350 degrees F. and 450 degrees F. where 400 degrees F. is preferred, for a duration of 40 seconds to 65 seconds, where 50 seconds is preferred, at a pressure of between 10 psi to 80 psi, where a pressure between 29 psi to 50 psi is preferred, to make a special event custom sign with text, background and graphics in color, block 24. The finished sign is examined for color, block 26. If one or more colors are not true, the not true color is modified using another Pantone color number or a color using Conde Systems—True Match Color Chart, block 28. A new transfer sheet having at least one modified color which replaces the undesired color is prepared, block 30, and a new special event custom sign with text, background and graphics in color is made, block 32 Examine new sign for color quality, block 34. If the color is now true, the last color image is used to print additional transfer papers for additional signs, where transfer paper is larger than the sign by at least one-eighth of an inch in each direction, block 36. The sign produced is a custom sign that can have college or university colors and/or logos or mascots, or corporation or company colors and/or logos for a collage, university, corporation or company function of event or any other function or event such as, for example, a marathon, a football game, etc. When the sign is for a marathon or a football game, the piece or blank can be made of cloth, plastic, paper, etc.

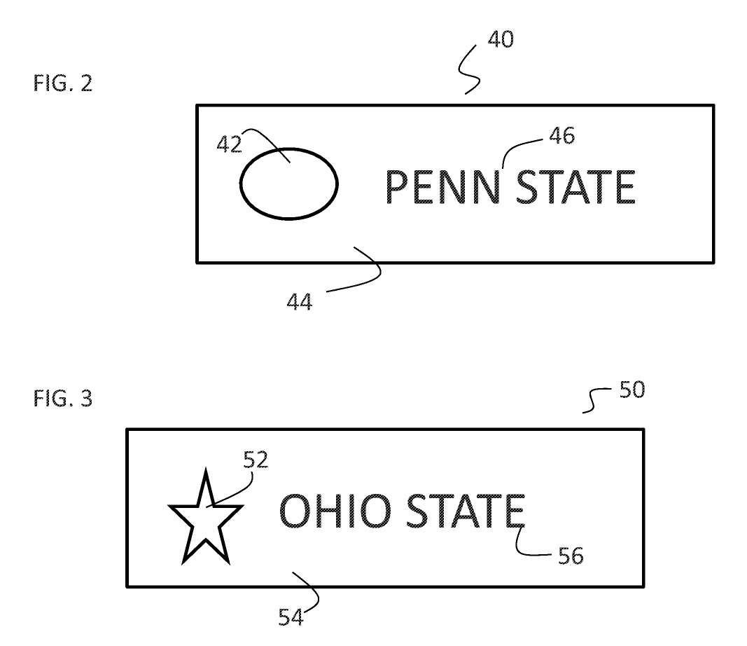

Referring to FIG. 2, there is shown a 4 inch by 12 inch completed special event custom sign 40 in color with text and graphics made with the disclose method. In FIG. 2 the oval 42 can be colored orange, the background 44 can be green, and the lettering 46 can be gold. FIG. 3 is a 4 inch by 18 inch completed special event custom sign 50 in color with text and graphics made with the disclosed method. In FIG. 3 the star 52 can be gold, the background 54 can be white, and the lettering 56 can be blue.

While there have been shown and described and pointed out the fundamental novel-features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A method of making a special event custom sign comprising:
providing a rectangular piece of sublimated aluminum;
preparing a first transfer paper having text and graphics in sublimatable colored ink;
wherein each color of the text and graphics is selected using a Pantone number;
overlaying the rectangular piece of sublimated aluminum with the first transfer paper;
transferring the text and graphics from the first transfer paper to the sublimated aluminum in a heat press for a time that is not less than 40 seconds or greater that 85 seconds to make a first multi-color sign;
preparing a second transfer paper having the same text and graphics as the first transfer paper with a number from the Conde Systems True Match Color Chart that replaces at least one color not desired; and
transferring the text and graphics from the second transfer paper to a second rectangular piece of sublimated aluminum in the heat press to make a second multi-color sign that improves, enhances and/or converts the color not desired;
wherein additional transfer papers having the same text and graphics as the second or a subsequent transfer paper that provides colors that are desired to make special event custom signs with text and graphics in color.

2. The method of claim 1 wherein said rectangular piece of sublimated aluminum is smaller than the transfer paper that overlays the piece of aluminum.

3. The method of claim 2 wherein the transfer paper is at least one eighth of an inch larger in length and width than the piece of sublimated aluminum.

4. The method of claim 2 wherein the time that the transfer paper and the sublimated aluminum is in the heat press is not less than 40 seconds and not greater than 65 seconds.

5. The method of claim 4 wherein the time that the transfer paper and the sublimated aluminum is in the heat press is between 45 seconds and 55 seconds.

6. The method of claim 2 wherein the heat of the heat press is between 350 degrees F. and 450 degrees F.

7. The method of claim 6 wherein the heat of the heat press is between 380 degrees F. and 420 degrees F.

8. The method of claim 2 wherein the pressure that is applied to the transfer paper and the sublimated aluminum is in the range of 10 psi to 80 psi.

9. The method of claim 8 wherein the pressure that is applied to the transfer paper and the sublimated aluminum is in the range of 15 psi to 65 psi.

10. The method of claim 1 wherein each color of the text and graphics selected for the first transfer paper is a number from Conde Systems True Match Color Chart.

11. The method of claim 10 wherein said new color that replaces at least one color not desired for said second transfer paper is a Pantone number.

12. The method of claim 1 wherein said special custom sign includes college or university colors for a college or university event or corporate colors and logo for a corporate function.

13. The method of claim 12 wherein said college or university colors and logos or mascots are identified by said college, university or corporate event.

14. The method of claim 12 wherein Pantone numbers are used to identify the colors of the college or university.

15. The method of claim 14 wherein each color of the text and graphics selected for the first transfer paper is a number from Conde Systems True Match Color Chart.

16. The method of claim 1 wherein said rectangular piece of sublimated aluminum is 4″×112″ cut from a sheet of sublimated aluminum that is 12″×24″.

17. The method of claim 16 wherein three rectangular sheets of sublimated aluminum that are 4″×20″ are cut from the sheet of sublimated aluminum after said 4″×12″ piece is cut.
